(19) United States
(12) Patent Application Publication
(10) Pub. No.: US 2009/0154585 A1
(43) Pub. Date: Jun. 18, 2009

(54) Channel estimation method and training signal creating method for channel estimation in mimo- ofdm system

(76) Inventors: Hyun Lee, Daejon (KR); Won-Chul Choi, Chungbuk (KR); Hyoung-Goo Jeon, Busan (KR)

Correspondence Address: STAAS & HALSEY LLP, SUITE 700, 1201 NEW YORK AVENUE, N.W., WASHINGTON, DC, 20005, US

(21) Appl. No.: 11/990,632

(22) PCT Filed: Dec. 2, 2005
(86) PCT No.: PCT/KR2005/004098

§ 371 Date: Feb. 19, 2008

(30) Foreign Application Priority Data
Aug. 19, 2005 (KR) 10-2005-0076479
Oct. 10, 2005 (KR) 10-2005-0095074

(51) Int. Cl. H04B 7/02

(52) U.S. Cl. 375/267

(57) ABSTRACT

Provided are a training signal generation method using impulse trains encoded with orthogonal codes and a channel estimation method using an orthogonal code decoding in a Multiple-Input Multiple-Output-Orthogonal Frequency Division Multiplex (MIMO-OFDM) system. The channel estimation method using the orthogonal code decoding in the MIMO-OFDM system includes the steps of creating a plurality of orthogonal codes depending on the number of receive antennas, decoding a signal received through each receive antenna by using the orthogonal codes, and estimating a channel response by averaging the received signals decoded with the orthogonal codes every OFDM symbol.

### TECHNICAL FIELD

The present invention relates to a channel estimation method and a training signal generation method for channel estimation in a Multiple-Input Multiple-Output-Orthogonal Frequency Division Multiplex (MIMO-OFDM) system. More particularly, the present invention is directed to a training signal generation method using impulse trains encoded with orthogonal codes (e.g., Walsh codes) and a channel estimation method using an orthogonal code decoding in the MIMO-OFDM system, wherein channel estimation is performed simply and exactly by generating and transmitting impulse trains encoded with orthogonal codes as a training signal at a transmitting end, and decoding a received signal with orthogonal codes and then averaging a decoded signal at a receiving end.

### BACKGROUND ART

MIMO technology refers to a technology that can improve a transfer rate without any increase of bandwidth by sending separate data from each of a plurality of antennas arranged at a transmitting end and a receiving end.

It is also known that OFDM is a frequency multiplexing scheme that distributes data to a multiplicity of orthogonal carriers and transmits the same. In other words, the OFDM refers to a frequency multiple communications scheme that can separate each carrier at a receiver by giving an orthogonal condition between the carriers although a part of transmission band is overlapped.

Therefore, the MIMO-OFDM technology is a technology into which the MIMO technology and the OFDM technology are converged, and is based on the fact that the theoretical channel capacity is increased in proportion to a small number out of the number of transmit and receive antennas when each antenna sends different data. Namely, since the amount of data to be sent is increased in proportion to the number of antennas, the feature of the MIMO-OFDM technology is that it can elevate the data transfer rate per unit time without any additional bandwidth.

FIG. 1 is a diagram illustrating a configuration of a conventional MIMO-OFDM system, which employs Nt number of transmit antennas and Nr number of receive antennas.

As shown in FIG. 1, user data b[l, k] is first applied to an MIMO encoding and symbol mapping unit 11 in the MIMO-OFDM system, wherein the data is encoded and mapped to symbols. Then, the mapped data is orthogonal frequency-transformed through an Inverse Fast Fourier Transformer (IFFT) unit 12 and sent. Each of IFFTs 121 to 123 included in the IFFT unit 12 simultaneously processes the outputs from the MIMO encoding and symbol mapping unit 11 in parallel; and thus, the number thereof is set to correspond to that of the outputs from the MIMO encoding and symbol mapping unit 11.

Connected to the IFFT unit 12 is a transmit antenna unit 13 composed of a multiplicity of transmit antennas which serves to send the transmission signals from the IFFT 12 to radio environment.

On the other hand, the transmission signals sent to the radio environment via the multiplicity of transmit antennas 13 are mixed and then received by each receive antenna of a receive antenna unit 14 at a receiving end.

Connected to the receive antenna unit 14 is an FFT unit 15 that performs an FFT with respect to each signal received through Nr number of receive antennas. Outputs of the FFT unit 15 may be represented by:

$${Y}_{j} [ l , k ] = {\sum }_{i = 1}^{{N}_{1}} {H}_{ij} [ l , k ] {X}_{i} [ l , k ] + {Ω}_{j} [ l , k ] , j = 1 , 2 , … , {N}_{R} \qquad Eq . ( 1 )$$

wherein denotes a Hᵢⱼ[l, k] frequency response of multi-path channel between an ith transmit antenna and a jth receive antenna for kth subchannel at a lth symbol interval, and indicates Ωᵢ[l,k] an FFT output of Additive White Gaussian Noise (AWGN) of which average is 0 and variance is σ²_{Ω}.

Signals, which the transmission signals are mixed with each other, received through the respective receive antennas 14 are transformed into corresponding time domain signals by the FFT unit 15. For the above purpose, the receiving end needs FFTs 151 to 153 as many as the number of antennas, like the transmitting end.

The signals from each of the FFTs 151 to 153 are frequency domain signals transformed from the mixed signals received through the receive antennas; and therefore, a detection block is required to separate each from them, wherein an MIMO decoding and symbol demapping unit 16 is served as the detection block.

As detection algorithms used in the MIMO-OFDM system, there are Minimum Mean Square Error (MMSE), Vertical Bell Lab Layered Space Time (VBLAST), Zero Forcing (ZF), Maximum Likelihood (ML) and so on. The performance of those detection algorithms mostly depends on the accuracy of a channel estimator 17 of subchannels between the antennas. And, connected to the channel estimator 17 is a symbol mapping unit 18 additionally provided by the detection algorithm.

In the detection algorithm, if estimation errors are involved in estimated channel coefficients, the transmission signal of each transmit antenna is not correctly separated from the received signals. As a result, signals from other transmit antennas remain in noise form, which yields a reduction in the performance of the MIMO-OFDM system. To improve the performance of the MIMO-OFDM system, therefore, there is required a technique capable of accurately estimating a channel in the multi-path fading environment above all things.

One of prior arts of estimating such channel is a channel estimation method based on an MMSE technique using a delay profile of impulse channel response. This method effectively removes AWGN components by taking into account the length of channel response in time domain. However, such method should solve complicated inverse matrix and abruptly increases the amount of calculation as the length of channel response becomes longer and the number of transmit and receive antennas becomes increased.

In order to reduce the complexity in the calculation that is the problem of the channel estimation method based on the MMSE technique as mentioned above, there is proposed a technique of estimating a channel with the delay profile of channel without using the inverse matrix. Namely, this technique estimates the channel in such a way that each antenna transmits a training signal with a different time delay in time domain not to mix channel responses with each other at a receiving end.

This technique is simple compared to the MMSE channel estimation method, but still has a complicated structure. Furthermore, the technique has a feedback structure that the accuracy of previous channel estimation value affects that of current channel estimation a lot. Due to such a feedback structure, it is difficult to apply the technique to systems at low SNR or environments where channel change is rapidly made.

### DISCLOSURE

### Technical Problem

It is, therefore, an object of the present invention to provide a training signal generation method using an impulse train encoded with orthogonal codes in an MIMO-OFDM system for generating and transmitting impulse trains encoded with orthogonal codes (Walsh codes) as a training signal for channel estimation at a receiving end.

Another object of the present invention is to provide a channel estimation method using an orthogonal code decoding in an MIMO-OFDM system, which is capable of easily and exactly performing channel estimation by decoding a received signal with orthogonal codes and then averaging a decoded signal.

The other objectives and advantages of the invention will be understood by the following description and will also be appreciated by the embodiments of the invention more clearly. Further, the objectives and advantages of the invention will readily be seen that they can be realized by the means and its combination specified in the claims.

### Technical Solution

In accordance with one aspect of the present invention, there is provided a training signal generation method using an impulse train encoded with orthogonal codes for channel estimation at a receiving end in a Multiple-Input Multiple-Output-Orthogonal Frequency Division Multiplex (MIMO-OFDM) system, the method including the steps of: creating a plurality of orthogonal codes based on the number of transmit antennas; and generating a training signal composed of impulse trains encoded with the orthogonal codes with respect to each transmit antenna.

In accordance with another aspect of the present invention, there is provided a channel estimation method using an orthogonal code decoding in an MIMO-OFDM system, the method including the steps of: creating a plurality of orthogonal codes depending on the number of receive antennas; decoding a signal received through each receive antenna by using the orthogonal codes; and estimating a channel response by averaging the received signals decoded with the orthogonal codes every OFDM symbol.

### ADVANTAGEOUS EFFECTS

The present invention has an advantage in that it can improve the quality of received signal by estimating radio channel more accurately with a small amount of calculation by means of designing a training signal for channel estimation between antennas using the orthogonality of Walsh codes under environments where serious noise exists such as radio channel.

In addition, the present invention has a merit that noise variance can be remarkably reduced through the Walsh decoding process and zero-padding for channel estimation at the receive antenna end.

### DESCRIPTION OF DRAWINGS

The above and other objects and features of the present invention will become apparent from the following description of the preferred embodiments given in conjunction with the accompanying drawings, in which:

FIG. 1 is a diagram illustrating a configuration of a conventional MIMO-OFDM system;

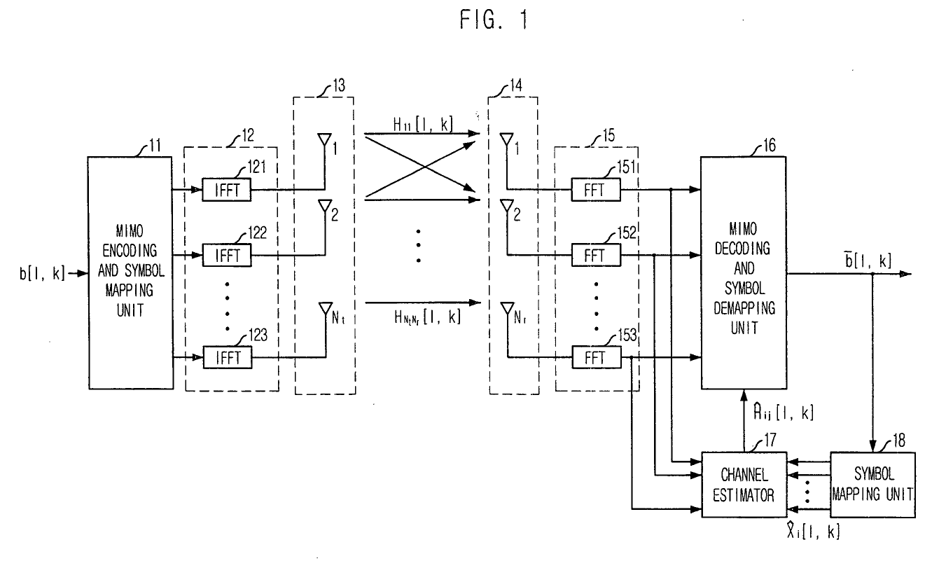

FIG. 2 is a view of describing a training signal generation method using Walsh-encoded impulse trains and a channel estimation method using Walsh decoding in an MIMO-OFDM system in accordance with an embodiment of the present invention; and

FIG. 3 is a view of describing a Walsh-encoded training signal and an antenna received signal in the MIMO-OFDM system in accordance with the present invention.

### BEST MODE FOR THE INVENTION

The above-mentioned objectives, features, and advantages will be more apparent by the following detailed description in association with the accompanying drawings; and thus, the invention will be readily conceived by those skilled in the art to which the invention pertains. Further, in the following description, well-known arts will not be described in detail if it seems that they could obscure the invention in unnecessary detail. Hereinafter, preferred embodiments of the present invention will be set forth in detail with reference to the accompanying drawings.

First, a conventional OFDM technique will be explained simply, prior to describing the present invention in detail.

To prevent Inter Symbol Interference (ISI) in the OFDM, Cyclic Prefix (CP) with a longer length than that of channel response is provided therein. The length of CP is about ¼ of that of whole OFDM symbol by considering maximum response length of channel. Therefore, there may be channel responses 4 times during the length of one OFDM symbol in the time domain.

The present invention provides a method which transmits a training signal encoded with Walsh codes so that the MIMO-OFDM system can use the time response characteristic of channel as described above, and can enable exact channel estimation at a receiving end.

In other words, the present invention can transmit 4. Walsh-encoded impulse trains since 4 impulses can be accommodated in one OFDM symbol in consideration of maximum response length; and allows 4×4 MIMO-OFDM channels to estimate channel responses when 4 antennas send respective corresponding Walsh-encoded impulse trains.

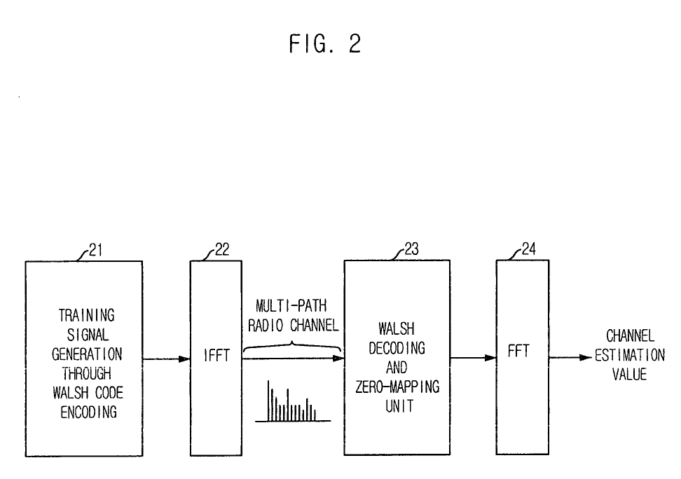

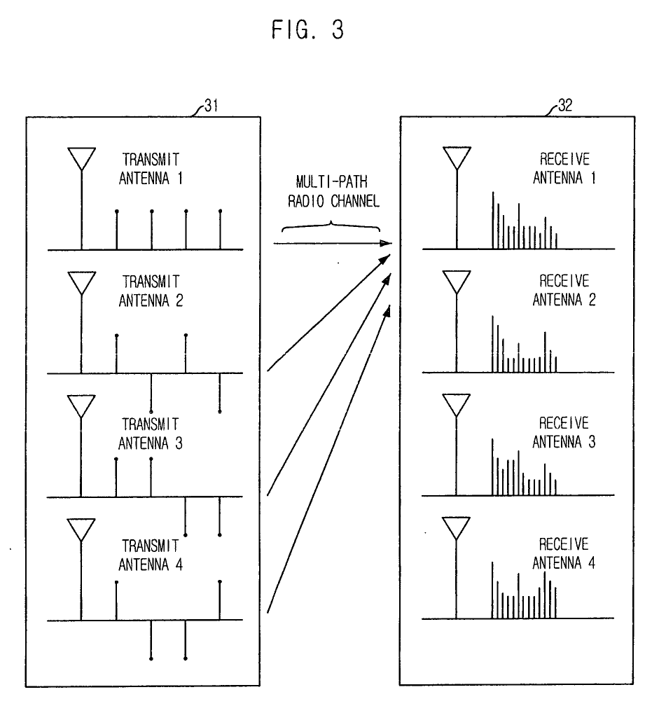

FIG. 2 is a view of describing a training signal generation method using Walsh-encoded impulse trains and a channel estimation method using Walsh decoding in the MIMO-OFDM system in accordance with an embodiment of the present invention. FIG. 3 is a view of describing a Walsh-encoded training signal and an antenna received signal in the MIMO-OFDM system in accordance with the present invention.

The present invention is applied to the MIMO-OFDM system, wherein a concept of the channel estimation method of the present invention will be described with reference to FIG. 2 below.

At a transmitting end, a training signal is first generated through Walsh encoding at a block 21, and then IFFT-transformed at a block 22. The IFFT-transformed signal is transmitted via a transmit antenna. Then, at a receiving end, a received signal is Walsh-decoded and zero-padded at a block 23, and then FFT-transformed at a block 24. By doing so, channels between respective transmit and receive antennas are estimated.

First of all, a description will be given below on a training signal generation method using Walsh-encoded impulse trains carried out at the transmitting end.

At the transmitting end, a plurality of Walsh codes should be generated based on the number of transmit antennas to create a training signal composed of impulse trains encoded with Walsh codes.

If the number of transmit and receive antennas is 4, respectively, the order of Walsh codes to be used is 4, which may be given by Eq. (2) below. At this time, in case where the number of transmit and receive antennas is more than 4, respectively, if 2 OFDM symbols are used and more order of Walsh codes is used, it is possible to expand until 8.

$$( \begin{matrix}{W}_{1} [ 1 ] , {W}_{1} [ 2 ] , {W}_{1} [ 3 ] , {W}_{1} [ 4 ] \\ {W}_{2} [ 1 ] , {W}_{2} [ 2 ] , {W}_{2} [ 3 ] , {W}_{2} [ 4 ] \\ {W}_{3} [ 1 ] , {W}_{3} [ 2 ] , {W}_{3} [ 3 ] , {W}_{3} [ 4 ] \\ {W}_{4} [ 1 ] , {W}_{4} [ 2 ] , {W}_{4} [ 3 ] , {W}_{4} [ 4 ]\end{matrix} ) = ( \begin{matrix}1 , & 1 , & 1 , & 1 \\ 1 , & - 1 , & 1 , & - 1 \\ 1 , & 1 , & - 1 , & - 1 \\ 1 , & - 1 , & - 1 , & 1\end{matrix} ) \qquad Eq . ( 2 )$$

Further, the Walsh codes described in Eq. (2) above have the orthogonality therebetween; and therefore, the following equation is obtained.

$$\frac{1}{4} {\sum }_{m = 1}^{1} {W}_{i} [ m ] {W}_{j} [ m ] = \{ \begin{matrix}1 , & if i = j \\ 0 , & otherwise\end{matrix} \qquad Eq . ( 3 )$$

If the number of transmit antennas is 4, Walsh-encoded training signals are shown in FIG. 3. That is, the training signals are transmitted from the transmit antenna 31 in such a manner that Walsh codes shown in Eq. (2) above are appeared in the time domain at maximum response time intervals (L samples).

At this time, the transmit antenna i utilizes Walsh codes. And, the training Wᵢ^{[m]} signal sent from the transmit antenna i may be represented as a discrete signal in the time domain by using a unit impulse function as follows:

isᵢ(n)=Wᵢ[1]δ[n]+Wᵢ[2]δ[n−L]+Wᵢ[3]δ[n−2L]+Wᵢ[4]δ[n−3L] Eq. (4)

wherein isᵢ(n) denotes an nth sample of a time domain training signal transmitted from the antenna i; n has the relationship 0≦n≦N 1 with N being the number of a total subchannels and being a value of 2's exponent power; δ[n] represents a unit impulse function with 1 only when n=0; and L(=N/4) denotes a maximum response length of OFDM signal. A Walsh-encoded training signal TSᵢ(n) in the frequency domain can be obtained by performing an FFT as:

TSᵢ(n)=FFT[isᵢ(n)] Eq. (5)

wherein FFT[ ] indicates a fast Fourier operation.

Now, the channel estimation method using Walsh decoding at the receiving will be described in detail. Like the transmitting end, the receiving end should also generate a plurality of Walsh codes depending on the number of receive antennas. Hereinafter, a description will be provided on an example where the number of transmit and receives antennas is 4, and Walsh codes are used, like the transmitting end.

As shown in FIG. 3, in the MIMO-OFDM system of the present invention, when isᵢ(n) signal is sent from each transmit antenna 31, the signal sent through each transmit antenna 31 is overlapped and received through each corresponding receive antenna 32.

This overlapped signal (received signal) contains the channel response of each antenna. Namely, the signal received through the receive antenna j is a signal overlapped by making the Walsh-encoded training signal from each transmit antenna passed through the channel. The received signal may be represented by:

$$\begin{matrix}{r}_{i} [ n ] = {\sum }_{j = 1}^{4} {ts}_{j} [ n ] ⋆ {h}_{ij} [ n ] \\ = {\sum }_{j = 1}^{4} ( \begin{matrix}{W}_{j} [ 1 ] {h}_{ij} [ n ] + {W}_{j} [ 2 ] {h}_{ij} [ n - L ] + \\ {W}_{j} [ 3 ] {h}_{ij} [ n - 2 L ] + {W}_{j} [ 4 ] {h}_{ij} [ n - 3 L ]\end{matrix} )\end{matrix} \qquad Eq . ( 6 )$$

wherein * denotes a convolution operator, and shows the time response of channel between the transmit antenna j and the receive antenna i. Considering the causal system, this may be given by:

if n<0 or L−1<n, then hᵢⱼ[n]0 Eq. (7)

The overlapped signal derived from Eqs. (6) and (7) above is subjected to the Walsh decoding process, wherein channel response between the respective corresponding antennas is separated. At this time, the Walsh decoding process is performed in the time domain very simply by using the orthogonality of Walsh codes described in Eq. (3) above.

For more convenient Walsh decoding, the received signal rᵢ[n] is divided into 4 intervals and thus may be represented as 2-dimensional arrangement signals as follows:

$$\begin{matrix}\begin{matrix}{r}_{i} [ 1 ] [ n ] = {r}_{i} [ n ] , \\ = {\sum }_{j = 1}^{4} {W}_{j} [ 1 ] {h}_{ij} [ n ] , 0 \leq n \leq L - 1\end{matrix} & Eq . ( 8 ) \\ \begin{matrix}{r}_{i} [ 2 ] [ n ] = {r}_{i} [ n + L ] , \\ = {\sum }_{j = 1}^{4} {W}_{j} [ 2 ] {h}_{ij} [ n ] , 0 \leq n \leq L - 1\end{matrix} & Eq . ( 9 ) \\ \begin{matrix}{r}_{i} [ 3 ] [ n ] = {r}_{i} [ n + 2 L ] , \\ = {\sum }_{j = 1}^{4} {W}_{j} [ 3 ] {h}_{ij} [ n ] , 0 \leq n \leq L - 1\end{matrix} & Eq . ( 10 ) \\ \begin{matrix}{r}_{i} [ 4 ] [ n ] = {r}_{i} [ n + 3 L ] , \\ = {\sum }_{j = 1}^{4} {W}_{j} [ 4 ] {h}_{ij} [ n ] , 0 \leq n \leq L - 1\end{matrix} & Eq . ( 11 )\end{matrix}$$

The overlapped channel responses of the diverse antennas in the time domain can be separated through Eq. (12) below that is the Walsh decoding process. In other words, the Walsh decoding is carried out by multiplying the signal received through each receive antenna by the corresponding Walsh codes. And then, the channel response is estimated by averaging the Walsh-decoded received signals every OFDM symbol.

$$\begin{matrix}\hat{{h}_{ij}} [ n ] = \frac{1}{4} {\sum }_{m = 1}^{4} {r}_{i} [ m ] [ n ] {W}_{j} [ m ] \\ = \frac{1}{4} {\sum }_{m = 1}^{4} ( {\sum }_{i = 1}^{4} {W}_{i} [ m ] {h}_{ij} [ n ] ) {W}_{j} [ m ] \\ = {\sum }_{i = 1}^{4} ( \frac{1}{4} {\sum }_{m = 1}^{4} {W}_{i} [ m ] {W}_{j} [ m ] ) {h}_{ij} [ n ]\end{matrix} \qquad Eq . ( 12 )$$

The channel response estimated by Eq. (12) above can be Walsh-decoded by using the orthogonality of Walsh codes described in Eq. (3) as:

$$if l = j , then \hat{{h}_{ij}} [ n ] = {h}_{ij} [ n ] \qquad Eq . ( 13 )$$

After separating the channel responses between the respective corresponding channels, zeros are padded to consider the delay profile of channel. That is, zero-padding is performed for a portion following data of guard interval every OFDM symbol. More specifically, the frequency response of channel can be derived by padding (N-L) number of zeros after h₅[n] and then performing an FFT.

In the above process, noise term is omitted for illustration of channel estimation. In case of considering the noise term, ¼ term is in the Walsh decoding process of Eq. (12) above, noise variance becomes reduced to ¼.

Therefore, the radio channel estimation apparatus and method in accordance with the present invention increases the accuracy of channel estimation while rendering implementation thereof simplified.

While the present invention has been described with respect to certain preferred embodiments, it will be apparent to those skilled in the art that various changes and modifications may be made without departing from the scope of the invention as defined in the following claims.

1. A training signal generation method using impulse trains encoded with orthogonal codes for channel estimation at a receiving end in a Multiple-Input Multiple-Output-Orthogonal Frequency Division Multiplex (MIMO-OFDM) system, the method comprising:
creating a plurality of orthogonal codes based on the number of transmit antennas; and
generating a training signal composed of impulse trains encoded with the orthogonal codes with respect to each transmit antenna.

2. The method as recited in claim 1, wherein if the number of transmit and receive antennas is 4, respectively, the orthogonal code creating Operation creates, as the orthogonal codes, Walsh codes as follows:
$$( \begin{matrix}{W}_{1} [ 1 ] , {W}_{1} [ 2 ] , {W}_{1} [ 3 ] , {W}_{1} [ 4 ] \\ {W}_{2} [ 1 ] , {W}_{2} [ 2 ] , {W}_{2} [ 3 ] , {W}_{2} [ 4 ] \\ {W}_{3} [ 1 ] , {W}_{3} [ 2 ] , {W}_{3} [ 3 ] , {W}_{3} [ 4 ] \\ {W}_{4} [ 1 ] , {W}_{4} [ 2 ] , {W}_{4} [ 3 ] , {W}_{4} [ 4 ]\end{matrix} ) = ( \begin{matrix}1 , & 1 , & 1 , & 1 \\ 1 , & - 1 , & 1 , & - 1 \\ 1 , & 1 , & - 1 , & - 1 \\ 1 , & - 1 , & - 1 , & 1\end{matrix} )$$

3. The method as recited in claim 2, wherein the training signal generating step generates the training signal for each transmit antenna by using the following:
isᵢ(n)=Wᵢ[1]δ[n]+Wᵢ[2]δ[n−L]+Wᵢ[3]δ[n−2L]+Wᵢ[4]δ[n−3L]
wherein denotes an nth sample of a time domain training signal transmitted from an antenna i, n has the relationship of 0≦n≦N−1 with N being the number of a total subchannels, δ[n] represents a unit impulse function with 1 only when n=0, and L denotes a maximum response length of OFDM signal.

4. A channel estimation method using an orthogonal code decoding in an MIMO-OFDM system, the method comprising the steps of:
creating a plurality of orthogonal codes depending on the number of receive antennas;
decoding a signal received through each receive antenna by using the orthogonal codes; and
estimating a channel response by averaging the received signals decoded with the orthogonal codes every OFDM symbol.

5. The method as recited in claim 4, further comprising:
zero-padding and performing Fast Fourier Transform (FFT) with respect to a portion following data of a guard interval every OFDM symbol.

6. The method as recited in claim 4, wherein if the number of transmit and receive antennas is 4, respectively, the orthogonal code creating operation creates, as the orthogonal codes, Walsh codes by using the equation described in claim 2.

7. The method as recited in claim 6, wherein if the number of receive antennas is 4, the channel estimating step estimate the channel response by the following:
$$\begin{matrix}\hat{{h}_{ij}} [ n ] = \frac{1}{4} {\sum }_{m = 1}^{4} {r}_{i} [ m ] [ n ] {W}_{j} [ m ] \\ = \frac{1}{4} {\sum }_{m = 1}^{4} ( {\sum }_{i = 1}^{4} {W}_{i} [ m ] {h}_{ij} [ n ] ) {W}_{j} [ m ] \\ = {\sum }_{i = 1}^{4} ( \frac{1}{4} {\sum }_{m = 1}^{4} {W}_{i} [ m ] {W}_{j} [ m ] ) {h}_{ij} [ n ]\end{matrix}$$
